(19) United States
(12) Patent Application Publication
(10) Pub. No.: US 2024/0271018 A1
(43) Pub. Date: Aug. 15, 2024

(54) BINDER COMPOSITE, ELECTROCHEMICAL APPARATUS, AND ELECTRIC APPARATUS

(71) Applicant: Ningde Amperex Technology Limited, Ningde (CN)

(72) Inventors: Kewen HU, Ningde (CN); Wei ZHUANG, Ningde (CN)

(73) Assignee: Ningde Amperex Technology Limited, Ningde (CN)

(21) Appl. No.: 18/437,303

(22) Filed: Feb. 9, 2024

(30) Foreign Application Priority Data
Feb. 14, 2023 (CN) 202310108797.6

(51) Int. Cl. C09J 123/12; H01M 50/46

(52) U.S. Cl. CPC C09J 123/12; H01M 50/461

(57) ABSTRACT

A binder composite, based on a mass of the binder composite, the binder composite includes the following components: main resin, 50% to 80%, the main resin including isotactic polyolefin resin, syndiotactic polyolefin resin, and atactic polyolefin resin; a tackifier, 5% to 20%; a toughener, 5% to 20%; and a plasticizer, 5% to 10%. Through selection of suitable components in appropriate proportions, the binder composite in this application achieves strong adhesion force and electrochemical stability. When applied in electrochemical apparatuses, the binder composite not only reduces the occurrence of internal short circuits resulting from the connection of positive and negative electrode plates in the electrochemical apparatuses, but also reduces side reactions between the binder composite and the electrolyte, thus reducing the formation of purple spots.

### CROSS REFERENCE TO RELATED APPLICATION

This application claims priority to the Chinese Patent Application Ser. No. 202310108797.6, filed on Feb. 14, 2023, the content of which is incorporated herein by reference in its entirety.

### TECHNICAL FIELD

This application relates to the field of electrochemical apparatus technologies, and specifically, to a binder composite, an electrochemical apparatus, and an electric apparatus.

### BACKGROUND

Electrochemical apparatuses are capable of storing and releasing electrical energy, and therefore have been widely used as power sources or energy storage apparatuses in electric apparatuses. As such electric apparatuses have become an indispensable part of people's lives, demands for their performance are also growing. Among these demands, safety and electrochemical performance of electrochemical apparatuses have become the primary concerns for users. Therefore, there is an urgent need to enhance the safety and electrochemical performance of electrochemical apparatuses.

### SUMMARY

This application provides a binder composite, an electrochemical apparatus, and an electric apparatus. The binder composite can improve the safety and electrochemical performance of electrochemical apparatuses.

According to a first aspect, this application provides a binder composite. Based on a mass of the binder composite, the binder composite includes the following components: a main resin being 50% to 80% by mass, the main resin including isotactic polyolefin resin, syndiotactic polyolefin resin, and atactic polyolefin resin; a tackifier being 5% to 20% by mass; a toughener being 5% to 20% by mass; and a plasticizer being 5% to 10% by mass.

Through selection of suitable components in appropriate proportions, the binder composite in this application achieves strong adhesion force and electrochemical stability. When applied in electrochemical apparatuses, the binder composite not only reduces the occurrence of internal short circuits resulting from the connection of positive and negative electrode plates in the electrochemical apparatuses, but also reduces side reactions between the binder composite and the electrolyte, thus reducing the formation of purple spots. Therefore, when applied in electrochemical apparatuses, the binder composite in this application can enhance the safety and electrochemical performance of the electrochemical apparatuses.

According to any of the foregoing embodiments of the first aspect of this application, based on a mass of the main resin, a mass percentage of the isotactic polyolefin resin is 40% to 85%, a mass percentage of the syndiotactic polyolefin resin is 10% to 40%, and a mass percentage of the atactic polyolefin resin is 5% to 25%. It should be noted that in addition to the isotactic polypropylene, syndiotactic polypropylene, and atactic polypropylene, the main resin may also contain substances such as some polymer monomers and catalysts, depending on the preparation process.

According to any of the foregoing embodiments of the first aspect of this application, based on the mass of the main resin, the mass percentage of the isotactic polyolefin resin is 45% to 70%, the mass percentage of the syndiotactic polyolefin resin is 20% to 35%, and the mass percentage of the atactic polyolefin resin is 10% to 20%.

According to any of the foregoing embodiments of the first aspect of this application, based on the mass of the main resin, the mass percentage of the isotactic polyolefin resin is 52% to 65%, the mass percentage of the syndiotactic polyolefin resin is 25% to 30%, and the mass percentage of the atactic polyolefin resin is 10% to 18%.

According to any of the foregoing embodiments of the first aspect of this application, a crystallinity of the isotactic polyolefin resin is 60% to 70%.

According to any of the foregoing embodiments of the first aspect of this application, an isotacticity of the isotactic polyolefin resin is ≥90%.

According to any of the foregoing embodiments of the first aspect of this application, water absorption of the isotactic polyolefin resin is 0.01% to 0.03%.

According to any of the foregoing embodiments of the first aspect of this application, a crystallization point of the syndiotactic polyolefin resin is lower than a crystallization point of isotactic polyolefin resin.

According to any of the foregoing embodiments of the first aspect of this application, a crystallinity of the syndiotactic polyolefin resin is 20% to 30%.

According to any of the foregoing embodiments of the first aspect of this application, a melting point of the syndiotactic polyolefin resin is 125° C. to 148° C.

According to any of the foregoing embodiments of the first aspect of this application, a density of the syndiotactic polyolefin resin is 0.7 g/cm³ to 0.8 g/cm³.

According to any of the foregoing embodiments of the first aspect of this application, a weight-average molecular weight Mw of the syndiotactic polyolefin resin and a viscosity-average molecular weight Mη of the syndiotactic polyolefin resin satisfy 1.7≤Mw/Mη≤2.6.

According to any of the foregoing embodiments of the first aspect of this application, a weight-average molecular weight of the atactic polyolefin resin is 3000 to 90000.

According to any of the foregoing embodiments of the first aspect of this application, the tackifier contains petroleum tackifying resin.

According to any of the foregoing embodiments of the first aspect of this application, the petroleum tackifying resin includes one or more of C5 hydrocarbon tackifying resin and C9 hydrocarbon tackifying resin.

According to any of the foregoing embodiments of the first aspect of this application, a weight-average molecular weight of the petroleum tackifying resin is 300 to 3000.

According to any of the foregoing embodiments of the first aspect of this application, the toughener has a functional group that forms a hydrogen bond.

According to any of the foregoing embodiments of the first aspect of this application, the functional group includes a carboxyl functional group.

According to any of the foregoing embodiments of the first aspect of this application, the toughener includes one or more of an ethylene-vinyl acetate copolymer or an ethylene-acrylic acid copolymer.

According to any of the foregoing embodiments of the first aspect of this application, the plasticizer includes rubber, where the rubber includes one or more selected from the group consisting of butadiene rubber, nitrile rubber, butyl rubber, chlorobutyl rubber, polysulfide rubber, polyurethane rubber, polyacrylate rubber, chlorinated polyethylene rubber, silicone rubber, fluorine rubber, polyisobutylene rubber, isoprene rubber, and ethylene-propylene rubber.

According to any of the foregoing embodiments of the first aspect of this application, based on the mass of the binder composite, the binder composite further includes: a surfactant, the surfactant being 1% to 5% by mass.

According to any of the foregoing embodiments of the first aspect of this application, the surfactant includes one or more selected from the group consisting of microcrystalline wax, paraffin wax, montan wax, polyethylene wax, and polypropylene wax.

According to a second aspect, this application provides an electrochemical apparatus including a negative electrode plate, a positive electrode plate, a separator, and an adhesive portion. The separator is provided between the negative electrode plate and the positive electrode plate, and the adhesive portion is provided on one side of the separator, where the adhesive portion is made of the binder composite according to the first aspect of this application.

According to any of the foregoing embodiments of the second aspect of this application, the separator includes a substrate and an extension portion connected to an edge of the substrate and extending beyond the negative electrode plate or the positive electrode plate, the adhesive portion being connected between two adjacent extension portions.

According to any of the foregoing embodiments of the second aspect of this application, the adhesive portion is provided on a surface of the separator.

According to any of the foregoing embodiments of the second aspect of this application, a swelling rate of the adhesive portion immersed in electrolyte at 60° C. for days is less than or equal to 10%.

According to any of the foregoing embodiments of the second aspect of this application, a dissolution rate of the adhesive portion immersed in electrolyte at 85° C. for 7 days is less than or equal to 5%.

According to any of the foregoing embodiments of the second aspect of this application, a Shore hardness of the adhesive portion is 58HA to 72HA.

According to any of the foregoing embodiments of the second aspect of this application, a longitudinal elongation at break of the adhesive portion is 20% to 150%.

According to any of the foregoing embodiments of the second aspect of this application, after the separators have been immersed in the electrolyte at 85° C. for 4 h, adhesion force per unit length between two adjacent separators is 15 N/m to 50 N/m.

According to any of the foregoing embodiments of the second aspect of this application, after the separator has been immersed in the electrolyte at 85° C. for 4 h, 24 adhesion force per unit length between the separator and the positive electrode plate is 5 N/m to 15 N/m.

According to any of the foregoing embodiments of the second aspect of this application, after the separator has been immersed in the electrolyte at 85° C. for 4 h, adhesion force per unit length between the separator and the negative electrode plate is 5 N/m to 15 N/m.

According to a third aspect, this application provides an electric apparatus including the electrochemical apparatus according to the second aspect of this application.

The foregoing description is merely an overview of the technical solution of this application. For a better understanding of the technical means in this application such that they can be implemented according to the content of the specification, and to make the above and other objectives, features, and advantages of this application more obvious and easier to understand, the following describes specific embodiments of this application.

### BRIEF DESCRIPTION OF DRAWINGS

Persons of ordinary skill in the art can clearly understand various other advantages and benefits by reading the detailed description of the preferred embodiments below. The accompanying drawings are merely intended to illustrate the preferred embodiments and are not intended to limit this application. In addition, in all the accompanying drawings, same parts are indicated by same accompanying symbols. In the accompanying drawings:

FIG. 1 is a schematic structural diagram of an electrode assembly with a stacked structure in an electrochemical apparatus according to some embodiments of this application.

FIG. 2 is a schematic structural diagram of an electrode assembly with a stacked structure in an electrochemical apparatus according to some embodiments of this application.

FIG. 3 is a schematic structural diagram of a separator and an adhesive portion in an electrochemical apparatus according to some embodiments of this application.

FIG. 4 is a schematic structural diagram of a separator and an adhesive portion in an electrochemical apparatus according to some other embodiments of this application.

FIG. 5 is a schematic structural diagram of a separator and an adhesive portion in an electrochemical apparatus according to still some other embodiments of this application.

In the accompanying drawings, the figures are not necessarily drawn to scale. Reference signs:

10. electrode assembly, 11. positive electrode plate, 12. negative electrode plate, 13. separator, 131. substrate, 132. extension portion, 133. heat-resistant layer, 14. adhesive portion.

### DETAILED DESCRIPTION

The following describes in detail the embodiments of technical solutions of this application with reference to the accompanying drawings. The following embodiments are merely intended for a clearer description of the technical solutions of this application and therefore are used as just examples which do not constitute any limitations on the protection scope of this application.

Unless otherwise defined, all technical and scientific terms used herein shall have the same meanings as commonly understood by those skilled in the art to which this application relates. The terms used herein are intended to merely describe the specific embodiments rather than to limit this application. The terms “include”, “have”, and any other variations thereof in the specification, claims and brief description of drawings of this application are intended to cover non-exclusive inclusions.

In the description of the embodiments of this application, the terms “first”, “second”, and the like are merely intended to distinguish between different objects, and shall not be understood as any indication or implication of relative importance or any implicit indication of the number, sequence or primary-secondary relationship of the technical features indicated. In the description of the embodiments of this application, the meaning of “plurality” is at least two, unless otherwise specifically defined.

In this specification, reference to “embodiment” means that specific features, structures or characteristics described with reference to the embodiment may be incorporated in at least one embodiment of this application. The word “embodiment” appearing in various positions in the specification does not necessarily refer to the same embodiment or an independent or alternative embodiment that is exclusive of other embodiments. It is explicitly or implicitly understood by persons skilled in the art that the embodiments described herein may be combined with other embodiments.

In the description of the embodiments of this application, the term “and/or” is only an associative relationship for describing associated objects, indicating that three relationships may be present. For example, A and/or B may indicate the following three cases: presence of only A, presence of both A and B, and presence of only B. In addition, the character “/” in this specification generally indicates an “or” relationship between contextually associated objects.

In the description of the embodiments of this application, unless otherwise stated, “above” and “below” mean inclusion of the number itself, “more types” in “one or more types” means at least two types, and “a plurality” means two or more.

Groupings of alternative elements or embodiments disclosed herein should not be construed as limitations. Each member of a group can be individually adopted and separately claimed for protection, or can be adopted and claimed for protection in any combination with other members of the group or other elements found herein. It is anticipated that one or more members of a group can be included in or deleted from the group for reasons of convenience and/or patentability. When any such inclusion or deletion occurs, the specification is herein deemed to contain the group as modified.

It is apparent to those skilled in the art that various modifications and changes can be made in this application without departing from the protection scope of this application. Therefore, this application is intended to cover the modifications and changes of this application that fall within the scope of the corresponding claims (claimed scope) and their equivalents. It should be noted that the implementations provided in the embodiments of this application can be combined with each other where not contradictory.

For easy understanding of the embodiments of this application, the problems existing in the related art are first specifically described in this application before the protection scope of the embodiments of this application are described.

In an electrochemical apparatus, typically a binder is used between the separators and between the separators and the positive or negative electrode plates to reduce the occurrence of short circuits between the positive and negative electrode plates. However, during use of the electric apparatus, mechanical abuses such as drops, collisions, and vibrations may occur. Due to insufficient adhesion force of the binder, the adhesion between the separators or between the separators and the positive or negative electrode plates will break, resulting in short circuits due to the connection of the positive and negative electrode plates, and reducing the safety performance of the electrochemical apparatus. Additionally, the poor electrochemical stability of the binder often leads to purple spots in the electrochemical apparatus, further reducing the electrochemical performance of the electrochemical apparatus. Therefore, there is an urgent need to improve the adhesion force and electrochemical stability of the binder, so that the safety and electrochemical performance of electrochemical apparatuses can be improved.

In view of this, this application provides a binder composite, an electrochemical apparatus, and an electric apparatus. The binder composite exhibits strong adhesion force and electrochemical stability, and can improve the safety and electrochemical performance of electrochemical apparatuses.

In this application, the electrochemical apparatus includes any apparatus in which an electrochemical reaction takes place. Specific examples of the apparatus include all types of primary batteries, secondary batteries, fuel batteries, solar batteries, or capacitors. For example, the electrochemical apparatus is a lithium secondary battery. The lithium secondary battery may include a lithium metal secondary battery, a lithium-ion secondary battery, a lithium polymer secondary battery, a lithium-ion polymer secondary battery, a sodium-ion battery, or the like.

### Binder Composite

According to a first aspect, this application provides a binder composite. Based on a mass of the binder composite, the binder composite includes the following components: a main resin being 50% to 80% by mass, the main resin including isotactic polyolefin resin, syndiotactic polyolefin resin, and atactic polyolefin resin; a tackifier being 5% to 20% by mass; a toughener being 5% to 20% by mass; and a plasticizer being 5% to 10% by mass.

In this application, isotactic means that methyl groups (—CH₃) in the molecular chain are distributed on one side of the main chain. Syndiotactic means methyl groups (—CH₃) in the molecular chain are symmetrically distributed on both sides of the main chain. Atactic means that methyl groups (—CH₃) are randomly distributed on both sides of the main chain.

The structure and proportion of organic compounds can be determined using well-known methods in the art, such as nuclear magnetic resonance spectroscopy. Nuclear magnetic resonance spectroscopy studies the absorption of radio frequency radiation by atomic nuclei in a strong magnetic field. It is one of the most powerful tools for qualitative analysis of the composition and structure of various organic and inorganic substances and can sometimes be used for quantitative analysis as well.

Through selection of suitable components in appropriate proportions, the binder composite in this application achieves strong adhesion force and electrochemical stability. When applied in electrochemical apparatuses, the binder composite not only reduces the occurrence of internal short circuits resulting from the connection of positive and negative electrode plates in the electrochemical apparatuses, but also reduces side reactions between the binder composite and the electrolyte, thus reducing the formation of purple spots. Therefore, when applied in electrochemical apparatuses, the binder composite in this application can enhance the safety and electrochemical performance of the electrochemical apparatuses.

In some embodiments of this application, based on a mass of the main resin, a mass percentage of the isotactic polyolefin resin is 40% to 85%, a mass percentage of the syndiotactic polyolefin resin is 10% to 40%, and a mass percentage of the atactic polyolefin resin is 5% to 25%. The mass percentages of the isotactic polyolefin resin, syndiotactic polyolefin resin, and atactic polyolefin resin are set within the above ranges. This helps to improve the adhesion force of the binder composite, reducing the occurrence of disconnection between the separators and between the separators and the positive and negative electrode plates when the electrochemical apparatus is subjected to mechanical abuse, and also allowing for a low voltage drop across the electrochemical apparatus, thereby improving the safety performance of the electrochemical apparatus. Additionally, such setting helps to enhance the electrochemical stability of the binder composite, reducing the swelling rate and dissolution rate of the binder composite during long-term use of the electrochemical apparatus, and reducing the appearance of oxidation peaks at 4.0 V to 4.5 V, which in turn reduces side reactions with the electrolyte and effectively alleviates the appearance of purple spots.

In some other embodiments of this application, the mass percentage of the isotactic polyolefin resin is 45% to 70%, the mass percentage of the syndiotactic polyolefin resin is 20% to 35%, and the mass percentage of the atactic polyolefin resin is 10% to 20%. The mass percentages of the isotactic polyolefin resin, syndiotactic polyolefin resin, and atactic polyolefin resin are set within the above ranges, which can further improve the adhesion force and electrochemical stability of the binder composite, further improving the safety performance of the electrochemical apparatus.

In still some embodiments of this application, based on the mass of the main resin, the mass percentage of the isotactic polyolefin resin is 52% to 65%, the mass percentage of the syndiotactic polyolefin resin is 25% to 30%, and the mass percentage of the atactic polyolefin resin is 10% to 18%. The mass percentages of the isotactic polyolefin resin, syndiotactic polyolefin resin, and atactic polyolefin resin are set within the above ranges, which can further improve the adhesion force and electrochemical stability of the binder composite, so that the electrochemical apparatus has better safety performance.

In some examples, based on the mass of the main resin, the mass percentage of the isotactic polyolefin resin may be but is not limited to 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 72%, 76%, 79%, 82%, 85%, or a range between any two of the above values. For example, the mass percentage of the isotactic polyolefin resin may be in a range of 41%-69%, 44%-65%, 46%-62%, 49%-58%, or 51%-56%.

In some examples, based on the mass of the main resin, the mass percentage of the syndiotactic polyolefin resin may be but is not limited to 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, or a range between any two of the above values. For example, the mass percentage of the syndiotactic polyolefin resin may be in a range of 11%-39%, 13%-36%, 16%-33%, or 21%-29%.

12 In some examples, based on the mass of the main resin, the mass percentage of the atactic polyolefin resin may be but is not limited to 5%, 6%, 7%, 8%, 9%, 10%, 11%, 12%, 13%, 14%, 15%, 16%, 17%, 18%, 19%, 20%, 21%, 22%, 23%, 24%, 25%, or a range between any two of the above values. For example, the mass percentage of the atactic polyolefin resin may be in a range of 6%-19%, 9%-16%, or 11%-14%.

In the embodiments of this application, the physical properties of the main resin such as crystallinity, isotacticity, water absorption, melting point, and density are within suitable ranges, which can enhance the adhesion force and electrochemical stability of the binder composite.

In some embodiments of this application, a crystallinity of the isotactic polyolefin resin is 60% to 70%. The crystallinity of the isotactic polyolefin resin is set within the above range, which can improve the tensile strength and yield strength of the main resin, and also increase the hardness of the main resin, thereby improving the deformation resistance after the binder composite forms an adhesive film.

In some examples, the crystallinity of the isotactic polyolefin resin may be but is not limited to 60%, 61%, 62%, 63%, 64%, 65%, 66%, 67%, 68%, 69%, 70%, or a range between any two of the above values. For example, the crystallinity of the isotactic polyolefin resin may be in a range of 61%-69% or 63%-66%.

In some embodiments of this application, an isotacticity of the isotactic polyolefin resin is ≥90%. The isotacticity of the isotactic polyolefin resin is set within the above range, enabling the adhesive film formed by the binder composite to have large adhesion force, low swelling and dissolution, small adhesive overflow, and good resistance to electrolyte.

In this application, isotacticity refers to a mass percent of the polyolefin resin that is insoluble in n-heptane under specified conditions. Therefore, the isotacticity can be obtained by placing an appropriate amount of polyolefin resin in n-heptane and comparing the mass of the polyolefin resin that is insoluble in n-heptane to the total mass of the polyolefin resin. The above method is the boiling n-heptane extraction method, which is also one of the simplest and most feasible methods for the determination of the isotacticity of polyolefin resin.

In some examples, the isotacticity of the isotactic polyolefin resin may be but is not limited to 90%, 91%, 92%, 93%, 94%, 95%, 96%, 97%, 98%, 99%, 100%, or a range between any two of the above values. For example, the isotacticity of the Isotactic polyolefin resin may be in a range of 91%-99% or 93%-96%.

In some embodiments of this application, water absorption of the isotactic polyolefin resin is 0.01% to 0.03%. The water absorption of the isotactic polyolefin resin is set within the above range, which can further improve the electrochemical stability of the binder composite, making the adhesive film formed thereof less prone to react with the electrolyte.

In this application, the water absorption has a meaning well known in the art, and can be measured by methods known in the art. For example, a moisture tester is used, the material under test is crushed into small pieces, and approximately 5 g of the small pieces is evenly spread on a stainless steel tray, followed by heating at 105° C. to 110° C. for 2 minutes, to obtain the water absorption.

In some examples, the water absorption of the isotactic polyolefin resin may be but is not limited to 0.010%, 0.011%, 0.012%, 0.013%, 0.014%, 0.015%, 0.016%, 0.017%, 0.018%, 0.019%, 0.020%, 0.021%, 0.022%, 0.023%, 0.024%, 0.025%, 0.026%, 0.027%, 0.028%, 0.029%, 0.030%, or a range between any two of the above values. For example, the water absorption of the Isotactic polyolefin resin may be in a range of 0.011%-0.029%, 0.013%-0.026%, 0.016%-0.023%, or 0.019%-0.021%.

In some embodiments of this application, a crystallization point of the syndiotactic polyolefin resin is lower than a crystallization point of the isotactic polyolefin resin.

In some embodiments of this application, a crystallinity of the syndiotactic polyolefin resin is 20% to 30%.

In some embodiments of this application, a melting point of the syndiotactic polyolefin resin is 125° C. to 148° C.

In some embodiments of this application, a density of the syndiotactic polyolefin resin is 0.7 g/cm³ to 0.8 g/cm³.

In some embodiments of this application, a weight-average molecular weight Mw of the syndiotactic polyolefin resin and a viscosity-average molecular weight Mη of the syndiotactic polyolefin resin satisfy 1.7≤Mw/Mη≤2.6.

In some embodiments of this application, a weight-average molecular weight of the atactic polyolefin resin is 3000 to 90000. The weight-average molecular weight of the atactic polyolefin resin is set within the above range, which can reduce the surface viscosity of the binder composite in forming the adhesive film, enhance its fluidity, and facilitate the formation of the adhesive film by the binder composite.

In some examples, the weight-average molecular weight of the atactic polyolefin resin may be but is not limited to 3000, 3500, 4000, 4500, 5000, 5500, 6000, 6500, 7000, 7500, 8000, 8500, 9000, 9500, 10,000, 10,500, 11,000, 11,500, 12,000, 12,500, 13,000, 13,500, 14,000, 14,500, 15,000, 15,500, 16,000, 16,500, 17,000, 17,500, 18,000, 18,500, 19,000, 19,500, 20,000, 30,000, 40,000, 50,000, 60,000, 70,000, 80000, 90000, or a range between any two of the above values. For example, the weight-average molecular weight of the atactic polyolefin resin may be in a range of 3500-80000, 5000-60000, 8000-40000, 10000-20000, or 12000-18000.

In some examples, the isotactic polyolefin resin may be isotactic polypropylene (iPP), the syndiotactic polyolefin resin may be syndiotactic polypropylene resin (sPP), and the atactic polyolefin resin may be atactic polypropylene resin (aPP).

In some embodiments of this application, the tackifier contains petroleum tackifying resin. The petroleum tackifying resin can improve the fluidity of the binder composite, and can also improve the adhesion force of the adhesive film formed by the binder composite.

In some embodiments of this application, the petroleum tackifying resin includes one or more of C5 hydrocarbon tackifying resin and C9 hydrocarbon tackifying resin.

In some embodiments of this application, a weight-average molecular weight of the petroleum tackifying resin is 300 to 3000.

In some examples, the weight-average molecular weight of the petroleum tackifying resin may be but is not limited to 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, or a range between any two of the above values. For example, the weight-average molecular weight of the petroleum tackifying resin may be in a range of 400-2900, 500-2700, 700-2100, 900-1900, or 1100-1600.

In some embodiments of this application, the toughener has a functional group that forms a hydrogen bond. The functional group is capable of forming hydrogen bonds, which reduces the crystallization of the toughener and reduces the formation of linear structure of its main chain. This in turn improves the toughness and longitudinal elongation at break of the adhesive film formed by the binder composite, thereby reducing the occurrence of fractures of the adhesive film formed by the binder composite, and further improving the safety performance of the electrochemical apparatus.

In some embodiments of this application, the functional group includes a carboxyl functional group. Such structure facilitates bonding with polar substances (such as aluminum foils and copper foils), providing extremely excellent adhesion.

In some embodiments of this application, the toughener includes one or more of an ethylene-vinyl acetate copolymer (EVA) or an ethylene-acrylic acid copolymer (EAA). The foregoing toughener enables the adhesive film formed by the binder composite to have good toughness and longitudinal elongation at break, further reducing the probability of fractures of the formed adhesive film.

In some embodiments of this application, the plasticizer includes rubber, where the rubber includes one or more selected from the group consisting of butadiene rubber, nitrile rubber, butyl rubber, chlorobutyl rubber, polysulfide rubber, polyurethane rubber, polyacrylate rubber, chlorinated polyethylene rubber, silicone rubber, fluorine rubber, polyisobutylene rubber, isoprene rubber, and ethylene-propylene rubber. The above rubbers can improve the initial adhesion and plasticity of the adhesive film formed by the binder composite, thereby further reducing the probability of fractures of the formed adhesive film.

In some embodiments of this application, based on the mass of the binder composite, the binder composite further includes: a surfactant, the surfactant being 1% to 5% by mass. The surfactant is set within the above range, which can enhance the surface drying speed during formation of the adhesive film by the binder composite and reduce the surface viscosity of the adhesive film.

In some examples, the mass percentage of the surfactant may be but is not limited to 1.0%, 1.5%, 2.0%, 2.5%, 3.0%, 3.5%, 4.0%, 4.5%, 5.0%, or a range between any two of the above values. For example, the mass percentage of the surfactant may be in a range of 1.5%-4.5% or 2.0%-4.0%.

In some embodiments of this application, the surfactant includes one or more selected from the group consisting of microcrystalline wax, paraffin wax, montan wax, polyethylene wax, and polypropylene wax. The foregoing surfactant enables the adhesive film formed by the binder to have a high surface drying speed and a low surface viscosity.

### Electrochemical Apparatus

According to a second aspect, this application provides an electrochemical apparatus including a negative electrode plate, a positive electrode plate, a separator, and an adhesive portion. The separator is provided between the negative electrode plate and the positive electrode plate, and the adhesive portion is provided on one side of the separator, where the adhesive portion is made of the binder composite according to the first aspect of this application.

In the electrochemical apparatus of this application, the adhesive portion is made of the binder composite according to the first aspect of this application. Therefore, when the electrochemical apparatus is subjected to mechanical abuse such as drops, collisions, or vibrations, the adhesion force of the adhesive portion allows the separator to reduce the probability of short circuits caused by the connection of the positive and negative electrode plates. In addition, the adhesive portion has good electrochemical stability, which can reduce its reactions with the electrolyte, and reduce the occurrence of purple spots. Therefore, the electrochemical apparatus provided in this application has good safety and electrochemical performance.

In some embodiments of this application, the separator includes a substrate and an extension portion connected to an edge of the substrate and extending beyond the negative electrode plate or the positive electrode plate, the adhesive portion being connected between two adjacent extension portions. The arrangement of the extension portions can further reduce the occurrence of short circuits between the positive and negative electrode plates. Further, the adhesive portion is connected between adjacent extension portions. The adhesive portion exhibits good adhesion force and electrochemical stability. This not only reduces the probability of internal short circuits between the positive and negative electrode plates when the electrochemical apparatus is subjected to mechanical abuse, but also reduces reactions between the adhesive portion and the electrolyte, reducing the occurrence of purple spots, thereby enhancing the safety and electrochemical performance of the electrochemical apparatus.

In some embodiments, the extension portion may be formed from an edge of the substrate along its length direction, or may be formed from an edge of the substrate along its width direction, or may be formed by the positive and negative electrode plates extending out along both the length direction and the width direction of the substrate.

In the foregoing embodiments, the appropriate shape of the adhesive portion facilitates the infiltration of the electrolyte into the electrode assembly, thereby improving the electrochemical performance of the electrochemical apparatus.

In some examples, the adhesive portion is wavy in shape, allowing the electrolyte to enter the electrode assembly through the gap between adjacent extension portions to facilitate infiltration of the electrode assembly.

In some embodiments of this application, an adhesive portion is provided on a surface of the substrate. The adhesive portion is provided on the surface of the substrate, helping secure the positive and negative electrode plates, and reducing the occurrence of short circuits between positive and negative electrode plates caused by mechanical abuse of the electrochemical apparatus.

Additionally, in some embodiments of this application, the separator further includes a heat-resistant layer, the heat-resistant layer being disposed between the substrate and the adhesive portion. The arrangement of this heat-resistant layer can enhance the heat-resistant performance of the separator, thereby reducing shrinkage of the separator at high temperatures, and improving the thermal safety performance of the electrochemical apparatus.

It can be understood that the heat-resistant layer and the adhesive portion may be provided sequentially on one side of the substrate, or the heat-resistant layer and the adhesive portion may be respectively provided on two sides of the substrate, which is not particularly limited in the embodiments of this application.

In some examples, the heat-resistant layer includes a ceramic layer, and the ceramic layer includes at least one of boehmite, alumina, or silicon dioxide.

In some embodiments of this application, a swelling rate of the adhesive portion immersed in electrolyte at 60° C. for 10 days is less than or equal to 10%.

In some embodiments of this application, a dissolution rate of the adhesive portion immersed in electrolyte at 85° C. for 7 days is less than or equal to 5%.

In this application, the swelling rate and dissolution rate have meanings known in the art and can be determined using methods known in the art. For example, the binder composite of this application is made into an adhesive film, and its mass is weighed using an electronic balance and recorded as m₀. The adhesive film is then immersed in electrolyte at 60° C. for 10 days. After that, the adhesive film is taken out, the electrolyte is wiped off from the surface, and the mass of the adhesive film is weighed using an electronic balance and recorded as m₁. The swelling rate is obtained according to the formula of swelling rate=(m₁−m₀)/m₀×100%.

The adhesive film, which had been immersed in the electrolyte at 60° C. for 10 days, was taken out and stored at 85° C. for 7 days. The mass of the adhesive film was weighed using an electronic balance and recorded as m₂. The dissolution rate is obtained according to the formula of dissolution rate=(m₂−m₀)/m₀×100%.

In the foregoing embodiments, the swelling rate of the adhesive portion that has immersed in the electrolyte at 60° C. for 10 days is set within the above range, which can further improve its electrochemical stability, and reduce the reactions with the electrolyte, thereby reducing the occurrence of purple spots, and improving the safety performance of the electrochemical apparatus. In addition, the dissolution rate of the adhesive portion that has immersed in the electrolyte at 85° C. for 7 days is set within the above range, which also can further improve its electrochemical stability, and reduce the reactions with the electrolyte, thereby reducing the occurrence of purple spots, and improving the safety performance of the electrochemical apparatus.

In some embodiments of this application, a Shore hardness of the adhesive portion is 58HA to 72HA.

In some embodiments of this application, a longitudinal elongation at break of the adhesive portion is 20% to 150%. The longitudinal elongation at break of the adhesive portion is set within the above range, which can reduce the disconnection of the object bonded by the adhesive portion, thereby improving the safety performance of the electrochemical apparatus.

In this application, the longitudinal elongation at break has a meaning well known in the art, and can be measured by methods known in the art, for example, measured using a universal testing machine in accordance with GB/T1040.

In some embodiments of this application, after the separators have been immersed in the electrolyte at 85° C. for 4 h, adhesion force per unit length between two adjacent separators is 15 N/m to 50 N/m.

In some embodiments of this application, after the separator has been immersed in the electrolyte at 85° C. for 4 h, adhesion force per unit length between the separator and the positive electrode plate is 5 N/m to 15 N/m.

In some embodiments of this application, after the separator has been immersed in the electrolyte at 85° C. for 4 h, adhesion force per unit length between the separator and the negative electrode plate is 5 N/m to 15 N/m.

In the foregoing embodiments, the adhesive portion made of the binder composite enables a strong adhesion force between the separators and between the separators and the positive and negative electrode plates, which in turn reduces the occurrence of disconnection between the separators and between the separators and the positive and negative electrode plates, thereby improving the safety performance of the electrochemical apparatus.

In this application, the adhesion force can be determined using known methods in the field. For example, the binder composite is applied between two separators, between the separator and the positive electrode plate, and between the separator and the negative electrode plate to make an adhesive portion, and the adhesion portion is cut into 20 mm*60 mm strip-shaped samples, where the length and width values can be adjusted proportionally according to the actual situation. The samples are subjected to hot pressing of 1 MPa at 85° C. for 40 minutes, followed by immersion in 85° C. electrolyte for 4 hours. Afterward, one side of the sample is adhered to a steel plate using 5000 NS double-sided adhesive, with an adhering length of not less than 40 mm. The steel plate is fixed at the appropriate position of a Gotech tension machine, and the part of the sample that is not adhered to the steel plate is pulled up either by using a connector or by directly clamping the electrode plate sample within the clamp, with the pulled-up part forming a 180° angle with the steel plate in space. The clamp pulls the sample at a speed of 5±0.2 mm/s, and the average pulling force in the steady range is finally obtained and recorded as the adhesion force.

In addition, in the foregoing embodiments, the separator substrate may be polyethylene, polypropylene, polyvinylidene fluoride, or a multi-layer composite film thereof. In some embodiments of this application, the separator is a single-layer separator or a multi-layer separator.

The shape and thickness of the separator are not particularly limited in the embodiments of this application. The preparation method of the separator is known in the art and can be used for preparing separators of electrochemical apparatuses.

In the embodiments of this application, the positive electrode plate includes a positive electrode current collector and a positive electrode active material layer that is disposed on at least one surface of the positive electrode current collector and that includes a positive electrode active material.

It can be understood that the positive electrode plate may be provided with a positive electrode active material layer on one surface of the positive electrode current collector, or may be provided with a positive electrode active material layer on both surfaces of the positive electrode current collector, which is not particularly limited in the embodiments of this application.

The positive electrode current collector may be a metal foil or a porous metal plate, for example, a foil or porous plate of metal such as aluminum, copper, nickel, titanium, iron, or alloys thereof. In some embodiments of this application, the positive electrode current collector is aluminum foil.

In some embodiments of this application, the positive electrode active material may include one or more selected from the group consisting of olivine-structured materials such as lithium manganese iron phosphate, lithium iron phosphate, and lithium manganese phosphate, ternary structure materials such as NCM811, NCM622, NCM523, and NCM333, lithium cobalt oxide material, lithium manganese oxide material, and other metal oxides capable of intercalating and deintercalating lithium.

In some embodiments of this application, the positive electrode active material layer further includes a binder. The binder enhances bonding between particles of the positive electrode active material, and also improves the binding between the positive electrode active material and the current collector. For example, the binder may include one or more selected from the group consisting of polyvinylidene fluoride, carboxymethyl cellulose, polyvinyl alcohol, hydroxypropyl cellulose, diacetyl cellulose, polyvinyl chloride, carboxylated polyvinyl chloride, polyvinyl fluoride, ethylene oxygen-based polymer, polyvinylpyrrolidone, polyurethane, polytetrafluoroethylene, polyvinylidene fluoride, polyethylene, polypropylene, styrene-butadiene rubber, acrylic (ester) styrene-butadiene rubber, epoxy resin, nylon, and the like.

In some embodiments of this application, the positive electrode active material layer further includes a conductive agent, and the conductive agent includes one or more selected from the group consisting of carbon-based material, metal-based material, conductive polymer, and a mixture thereof. For example, the carbon-based material includes carbon black, acetylene black, Ketjen black, carbon fiber, carbon nanotube, graphene, or any combination thereof. The metal-based material includes metal powder, metal fiber, copper, nickel, aluminum, or silver. The conductive polymer is a polyphenylene derivative.

The positive electrode plate of this application can be prepared according to conventional methods in the art. For example, the active material, conductive material, and binder are dispersed in N-methylpyrrolidone (NMP) to form a uniform positive electrode slurry; and the positive electrode slurry is applied onto the positive electrode current collector, followed by drying, cold pressing, cutting, slitting, and drying, to obtain a positive electrode plate.

The negative electrode plate may be provided with a negative electrode active material layer on one surface of the negative electrode current collector, or may be provided with a negative electrode active electrode layer on both surfaces of the negative electrode current collector, which is not particularly limited in the embodiments of this application.

The negative electrode current collector may be a metal foil or a porous metal plate, for example, a foil or porous plate of metal such as copper, nickel, titanium, iron, or alloys thereof. In some embodiments of this application, the negative electrode current collector is copper foil.

The negative electrode active material in the negative electrode active material layer may be one or more selected from the group consisting of silicon, silicon oxide compound (SiOₓ, 0<x≤2), silicon alloy, silicon-carbon compound, graphite, mesocarbon microbeads (MCMB), hard carbon, soft carbon, Li—Sn alloy, Li—Sn—O alloy, Sn, SnO, SnO₂, spinel-structure lithium titanate Li₄Ti₅O₁₂, Li—Al alloy, lithium metal, and the like. Through use of the materials described above, the energy density of the electrochemical apparatus can be improved.

In some embodiments of this application, the negative electrode active material layer further includes a binder. The binder may include one or more selected from the group consisting of styrene-butadiene rubber (SBR), polyacrylic acid (PAA), polyacrylic acid sodium (PAAS), polyacrylamide (PAM), polyvinyl alcohol (PVA), sodium alginate (SA), polymethacrylic acid (PMAA), and carboxymethyl chitosan (CMCS).

In some embodiments of this application, the negative electrode active material layer further includes a conductive agent. The conductive agent may include one or more selected from the group consisting of superconducting carbon, acetylene black, carbon black, Ketjen black, carbon dots, carbon nanotubes, graphene, and carbon nanofiber.

In some embodiments of this application, the negative electrode active material layer may further include other promoters such as a thickener (for example, carboxymethyl cellulose sodium (CMC-Na)) and carboxymethylcellulose lithium (CMC-Li).

However, this application is not limited to the above materials, and the negative electrode plate may also use other well-known materials that can be used as the negative electrode active material, conductive agent, binder, and thickener.

The negative electrode plate of this application can be prepared according to conventional methods in the art. For example, the negative electrode active material, conductive agent, binder, and thickener are dispersed in a solvent which may be N-methylpyrrolidone (NMP) or deionized water, to form a uniform negative electrode slurry; and the negative electrode slurry is applied to the negative electrode current collector, followed by drying and cold pressing, to obtain a negative electrode plate.

In an electrochemical apparatus, the electrolyte serves as the carrier for ion transport and facilitates the conduction of ions between the positive and negative electrode plates. It is essential for achieving advantages such as good cycling performance in the electrochemical apparatus.

The electrolyte may be prepared by using the conventional methods in the art. For example, the organic solvent, lithium salt, and optional additives can be well mixed to obtain the electrolyte, where the order of adding the materials is not particularly limited.

In the embodiments of this application, the positive electrode plate, the separator, and the negative electrode plate are sequentially stacked so that the separator is located between the positive electrode plate and the negative electrode plate to provide separation. Then the resulting stack is wound to obtain an electrode assembly. The electrode assembly is placed into a housing. Then electrolyte is injected, and processes such as vacuum sealing, standing, formation, degassing, and shaping are performed to obtain an electrochemical apparatus.

The housing may be a hard-shell housing or a flexible-shell housing. For example, the material for the hard-shell housing may be metal. The material for the flexible-shell housing may be a metal-plastic film, such as an aluminum-plastic film or a steel-plastic film.

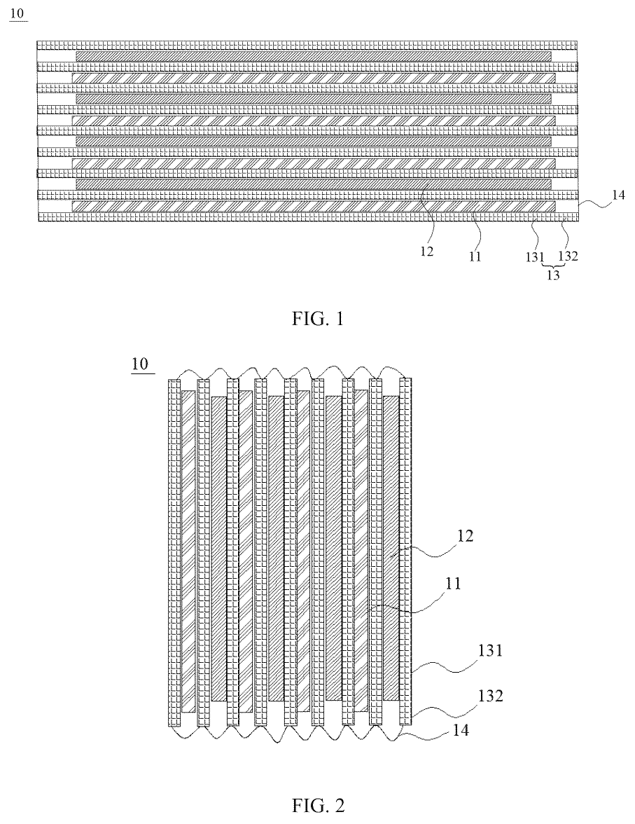

In some examples, FIG. 1 is a schematic structural diagram of an electrode assembly with a stacked structure in an electrochemical apparatus according to some embodiments of this application. As shown in FIG. 1, the electrode assembly 10 includes a positive electrode plate 11 and a negative electrode plate 12, a separator 13, and an adhesive portion 14. The separator 13 includes a substrate 131 and an extension portion 132 connected to an edge of the substrate 131 and extending beyond the positive electrode plate 11 or the negative electrode plate 12 along a length direction, the adhesive portion 14 being connected between two adjacent extension portions 132.

FIG. 2 shows another structure of the electrode assembly in some embodiments of this application. As shown in FIG. 2, the adhesive portion 14 is connected between adjacent extension portions 132, and the adhesive portion 14 is wavy in shape.

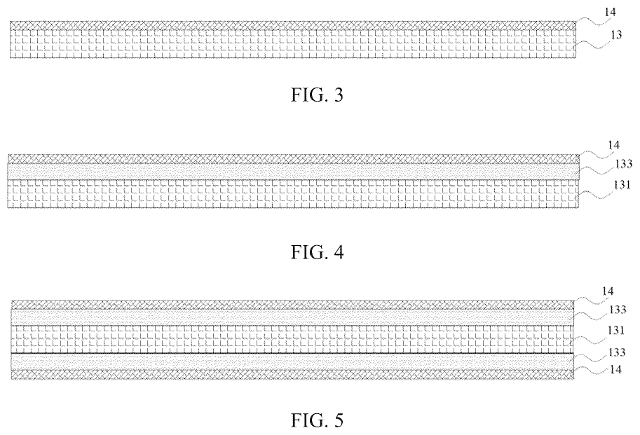

In addition, FIG. 3 shows a structure of a separator and an adhesive portion in some embodiments of this application. As shown in FIG. 3, the adhesive portion 14 is provided on a surface of the separator 13, so as to fix the positive electrode plate 11 and the negative electrode plate 12, thereby reducing the occurrence of short circuits between the positive electrode plate 11 and the negative electrode plate 12 caused by mechanical abuse of the electrochemical apparatus.

FIG. 4 shows another structure of a separator and an adhesive portion in some embodiments of this application. As shown in FIG. 4, the separator 13 includes a substrate 131 and a heat-resistant layer 133 disposed on one side of the substrate 131, the heat-resistant layer 133 being disposed between the substrate 131 and the adhesive portion 14. In still another example, FIG. 5 shows still another structure of a separator and an adhesive portion in some embodiments of this application. As shown in FIG. 5, a heat-resistant layer 133 is provided on each side of the substrate 131, the heat-resistant layer 133 being still disposed between the substrate 131 and the adhesive portion 14.

### Electric Apparatus

A second aspect of this application provides an electric apparatus including the electrochemical apparatus according to the first aspect of this application. The electrochemical apparatus provided in this application has good safety performance, so the electric apparatus including the electrochemical apparatus also has good safety performance.

The electric apparatus is not particularly limited in the embodiments of this application and may be any known electric apparatus in the prior art. In some embodiments of this application, the electric apparatus may include but is not limited to a notebook computer, a pen-input computer, a mobile computer, an electronic book player, a portable telephone, a portable fax machine, a portable copier, a portable printer, a stereo headset, a video recorder, a liquid crystal display television, a portable cleaner, a portable CD player, a mini-disc player, a transceiver, an electronic notebook, a calculator, a storage card, a portable recorder, a radio, a backup power source, a motor, an automobile, a motorcycle, a motor bicycle, a bicycle, a lighting appliance, a toy, a game machine, a clock, an electric tool, a flash lamp, a camera, a large household battery, a lithium-ion capacitor, or the like.

Content disclosed in this application is described in more detail in the following examples. These examples are merely intended for illustrative purposes because various modifications and changes made without departing from the scope of the content disclosed in this application are apparent to a person skilled in the art. Unless otherwise stated, all parts, percentages, and ratios reported in the following examples are based on masses, all reagents used in the examples are commercially available or synthesized in a conventional manner, and can be used directly without further treatment, and all instruments used in the examples are commercially available.

In the following embodiments, for ease of description, the electrochemical apparatus being a lithium-ion secondary battery is used as an example to describe the electrochemical apparatus and its manufacturing method.

### Example 1

### (1) Preparation of Electrolyte

In an environment with a water content less than 150 ppm (in a dry argon atmosphere), lithium salt LiPF₆ and non-aqueous organic solvents (ethylene carbonate (EC):diethyl carbonate (DEC):propylene carbonate (PC):propyl propionate (PP):vinylene carbonate (VC)=20:30:20:28:2, by mass) were mixed at a mass ratio of 2:23, and a resulting solution was used as an electrolyte of the lithium-ion battery.

### (2) Preparation of Positive Electrode Plate

A positive electrode active material lithium cobalt oxide (LiCoO₂), conductive carbon black (Super P), and polyvinylidene fluoride (PVDF) were mixed at a weight ratio of 97.5:1.0:1.5, added with N-methylpyrrolidone (NMP) as a solvent, and stirred to uniformity to obtain a positive electrode slurry with a solid content of 75%. The positive electrode slurry was evenly applied on a positive electrode current collector aluminum foil, and the aluminum foil was dried at 90° C., followed by cold pressing, cutting, and slitting, to obtain a positive electrode plate.

### (3) Preparation of Negative Electrode Plate

4 Copper foil was used as a negative electrode current collector. A layer of graphite slurry was uniformly applied on the surface of the copper foil. The slurry composition included 97.7 wt % artificial graphite, 1.3 wt % sodium carboxymethyl cellulose (CMC-Na), and 1.0 wt % styrene-butadiene rubber (SBR). The copper foil was dried under 90° C., followed by cold pressing, cutting, and slitting, to obtain the negative electrode plate.

### (4) Preparation of Separator

The separator substrate is made of polyethylene, and a region of the substrate extending beyond the positive or negative electrode plate to form an extension portion.

### (5) Preparation of Lithium-Ion Secondary Battery

The positive electrode plate, separator, and negative electrode plate were sequentially stacked so that the separator was located between the positive electrode plate and the negative electrode plate to provide separation; the binder composite was applied on the surface of the extension portion to make an adhesive portion; and the resulting stack was wound to form an electrode assembly. The electrode assembly was placed into a housing, the prepared electrolyte was injected into the housing, and after steps such as vacuum packaging, standing, formation, and shaping, a lithium-ion secondary battery was obtained.

### Examples 2 to 13

The preparation method was similar to the preparation method of Example 1, with the difference lying in the components and their proportions in the binder composite for making the adhesive portion.

### Comparative Examples 1 to 3

The preparation method was similar to the preparation method of Example 1, with the difference in that: the extension portions of the separator extending beyond the positive and negative electrode plates were connected by the adhesive portion made from polyacrylic acid adhesive paper, polyolefin adhesive paper, or SIS adhesive paper.

### Example 14

### (1) Preparation of Electrolyte

In an environment with a water content less than 150 ppm (in a dry argon atmosphere), lithium salt LiPF₆ and non-aqueous organic solvents (ethylene carbonate (EC):diethyl carbonate (DEC):propylene carbonate (PC):propyl propionate (PP):vinylene carbonate (VC)=20:30:20:28:2, by mass) were mixed at a mass ratio of 2:23, and a resulting solution was used as an electrolyte of the lithium-ion battery.

### (2) Preparation of Positive Electrode Plate

A positive electrode active material lithium cobalt oxide (LiCoO₂), conductive carbon black (Super P), and polyvinylidene fluoride (PVDF) were mixed at a weight ratio of 97.5:1.0:1.5, added with N-methylpyrrolidone (NMP) as a solvent, and stirred to uniformity to obtain a slurry with a solid content of 75%. The slurry was evenly applied on a positive electrode current collector aluminum foil, and the aluminum foil was dried at 90° C., followed by cold pressing, cutting, and slitting, to obtain a positive electrode plate.

### (3) Preparation of Negative Electrode Plate

Copper foil was used as a negative electrode current collector. A layer of graphite slurry was uniformly applied on the surface of the copper foil. The slurry composition included 97.7 wt % artificial graphite, 1.3 wt % sodium carboxymethyl cellulose (CMC-Na), and 1.0 wt % styrene-butadiene rubber (SBR). The copper foil was dried under 90° C., followed by cold pressing, cutting, and slitting, to obtain a negative electrode plate.

### (4) Preparation of Separator

The separator substrate was made from polyethylene, and the binder composite was applied on both sides of the substrate to form an adhesive portion. The components of the binder composite and their proportions were the same as those of the binder composite in Example 3.

### (5) Preparation of Lithium-Ion Secondary Battery

The positive electrode plate, separator, and negative electrode plate were sequentially stacked so that the separator was located between the positive electrode plate and the negative electrode plate to provide separation. Then, the resulting stack was wound to form an electrode assembly. The electrode assembly was placed into a housing, the prepared electrolyte was injected into the housing, and after steps such as vacuum packaging, standing, formation, and shaping, a lithium-ion secondary battery was obtained.

### Example 15

The preparation method was similar to that of Example 1, with the difference in that: a first surface of the separator substrate was first coated with a ceramic layer and then coated with the binder composite to form an adhesive portion, and a second side was directly coated with the binder composite to form an adhesive layer, the first side and second side of the substrate being disposed opposite each other.

### Comparative Example 4

The preparation method was similar to the preparation method of Example 1, with the difference in that: both the first side and second side of the separator substrate were coated with polyacrylic acid.

### Comparative Example 5

The preparation method was similar to that of Example 1, with the difference in that: the first surface of the separator substrate was first coated with a ceramic layer and then coated with polyacrylic acid, and the second side was directly coated with polyacrylic acid.

### Comparative Example 6

The preparation method was similar to the preparation method of Example 1, with the difference in that: both the first side and second side of the separator substrate were coated with polyvinylidene fluoride (PVDF).

### Comparative Example 7

The preparation method was similar to that of Example 2, with the difference in that: the first surface of the separator substrate was first coated with a ceramic layer and then coated with polyvinylidene fluoride (PVDF), and the second side was directly coated with polyvinylidene fluoride (PVDF).

### Tests

### (1) Drop Test

a. The battery levels of 10 batteries were all adjusted to 68% SOC and the drop fixture was cleaned before the drop test.
b. The voltages and internal resistances of the batteries were measured before the test (the baseline voltage before the drop was measured after charging and standing for 2 hours, and it was determined that the battery voltage was 3.94 V to 3.99 V before the drop).
c. The compression equipment and compression fixture were used. The battery was placed in the metal fixture and compressed with a 5 kg press block for 7 seconds immediately (within 1 minute) after the fixture was tightened against the battery.
d. The voltage and internal resistance were measured after 1 hour of standing, and the battery was checked for any appearance damage, leakage, swelling, or corrosion. After the check was complete, the fixture was covered with the cover plate and the screws were tightened.
e. Manual drop test (using a 10 mm iron plate): The battery was dropped freely from a height of 1.8 m in the following order: head>tail>upper right corner>lower right corner>upper left corner>lower left corner (angle: 45±15 degrees), with these six directions downward. The test was repeated for 7 rounds.
f. After each round of testing, if leakage, heat, smoke, or fire was found and the voltage drop is ≥50 mV, next drop was stopped. After the drop was complete, the battery was taken and left standing for 24 hours at room temperature, and then the voltage and internal resistance were measured.

### (2) Purple Spot Test

A. Cycling test
(a) Test temperature was 25° C.
(b) The battery was left standing for 60 min.
(c) The battery was charged to 4.16 V at a constant current of 8.2 A.
(d) The battery was charged to 4.25 V at a constant current of 6 A.
(e) The battery was charged to 4.48 V at a constant current of 2C, and then constant-voltage charged to 0.05C.
(f) The battery was left standing for 5 min.
(g) The battery was constant-current discharged to 3 V at 0.7C.
(h) The battery was left standing for 5 min.
(i) Steps (3) to (8) were repeated for 1000 times.
B. Battery capacity testing process in cycling: the battery capacity P was measured at the first cycle, and from the first cycle to the 1000th cycle, the battery capacity P was measured once every 50 cycles.
(a) Test temperature was 25° C.
(b) The battery was left standing for 5 min.
(c) The battery was discharged to 3 V at a constant current of 0.2C.
(d) The battery was left standing for 5 min.
(e) After the cycling, the battery was disassembled and checked for any purple spot at the interface.

### (3) Adhesion Force Test

The binder composite was applied between two separators, between the separator and the positive electrode plate, and between the separator and the negative electrode plate to make an adhesive portion, and the adhesion portion was cut into 20 mm*60 mm strip-shaped samples, where the length and width values could be adjusted proportionally according to the actual situation. The samples were subjected to hot pressing of 1 MPa at 85° C. for 40 minutes, followed by immersion in 85° C. electrolyte for 4 hours. Afterward, one side of the sample was adhered to a steel plate using 5000 NS double-sided adhesive, with an adhering length of not less than 40 mm. The steel plate was fixed at the appropriate position of a Gotech tension machine, and the part of the sample that was not adhered to the steel plate was pulled up either by using a connector or by directly clamping the electrode plate sample within the clamp, with the pulled-up part forming a 180° angle with the steel plate in space. The clamp pulled the sample at a speed of 5±0.2 mm/s, and the average pulling force in the steady range was finally obtained and recorded as the adhesion force.

### (4) Button Cell Cyclic Voltammetry (CV) Test

The separator coated with the binder composite was made into the test sample, and the test sample was subjected to scanning in a voltage range of 3 V to 5 V, first positively from the open-circuit voltage to 5 V and then negatively to 3 V, with a scanning speed of 0.05 mV/s, a voltage accuracy of ±0.1%, and a current accuracy of ±0.1%, to obtain the current-voltage curve. When the battery experienced an oxidation or reduction reaction within the test voltage range, a significant change in current could be observed.

TABLE 1

| | Main resin | | | | | | Plasticizer | Surfactant | | |
|---|---|---|---|---|---|---|---|---|---|---|
| | | Based on mass of main resin | | | Tackifier | Toughener | Percentage | Percentage | | |
| | Total | Per- | Per- | Per- | Per- | Per- | of styrene- | of micro- | Adhesion | |
| | per- | centage | centage | centage | centage | centage | butadiene | crystalline | force | Shore |
| No. | centage | of iPP | of sPP | of aPP | of C5 | of EVA | rubber | wax | (N/m) | hardness |
| Example 1 | 50% | 60% | 30% | 10% | 20% | 20% | 5% | 5% | 16.7 | 62 |
| Example 2 | 65% | 60% | 30% | 10% | 8% | 20% | 5% | 2% | 30.8 | 66 |
| Example 3 | 80% | 60% | 30% | 10% | 5% | 5% | 8% | 2% | 48.9 | 72 |
| Example 4 | 70% | 60% | 30% | 10% | 15% | 7% | 7% | 1% | 30.3 | 66 |
| Example 5 | 65% | 30% | 45% | 25% | 10% | 12% | 10% | 3% | 50.0 | 658 |
| Example 6 | 65% | 40% | 40% | 20% | 10% | 12% | 10% | 3% | 48.3 | 64 |
| Example 7 | 65% | 45% | 35% | 20% | 10% | 12% | 10% | 3% | 44.6 | 66 |
| Example 8 | 65% | 52% | 30% | 18% | 10% | 12% | 10% | 3% | 40.5 | 68 |
| Example 9 | 65% | 57% | 29% | 14% | 10% | 12% | 10% | 3% | 36.8 | 68 |
| Example 10 | 65% | 65% | 25% | 10% | 10% | 12% | 10% | 3% | 32.3 | 70 |
| Example 11 | 65% | 70% | 20% | 10% | 10% | 12% | 10% | 3% | 26.2 | 71 |
| Example 12 | 65% | 85% | 10% | 5% | 10% | 12% | 10% | 3% | 20.5 | 72 |
| Example 13 | 65% | 90% | 6% | 4% | 10% | 12% | 10% | 3% | 15.0 | 72 |

| | | | |
|---|---|---|---|
| Comparative | Polyacrylic acid adhesive paper | 0 | 55 |
| Example 1 | | | |
| Comparative | Polyolefin adhesive paper | 0 | 67 |
| Example 2 | | | |
| Comparative | SIS adhesive paper | 0 | 78 |
| Example 3 | | | |

| | | | | Oxidation peak | | | Drop test | |
|---|---|---|---|---|---|---|---|---|
| | Longitudinal | | | intensity | Purple spot | | | Number of |
| | elongation | Swelling | Dissolution | before 4.5 V | Extension | | 24 h voltage | separator |
| No. | at break | rate | rate | in CV test | portion | Corner | drop >50 mV | shrinkages |
| Example 1 | 144% | 9.7% | 4.8% | 0.009 | No | No | 0/10 | 0 |
| Example 2 | 92% | 6.7% | 3.7% | 0.005 | No | No | 0/10 | 0 |
| Example 3 | 35% | 3.5% | 1.4% | 0.002 | No | No | 0/10 | 0 |
| Example 4 | 78% | 6.7% | 3.9% | 0.006 | No | No | 0/10 | 0 |
| Example 5 | 150% | 7.0% | 4.3% | 0.006 | No | No | 1/10 | 0 |
| Example 6 | 102% | 6.8% | 4.1% | 0.006 | No | No | 0/10 | 0 |
| Example 7 | 101% | 6.3% | 3.7% | 0.005 | No | No | 0/10 | 0 |
| Example 8 | 100% | 5.3% | 2.8% | 0.005 | No | No | 0/10 | 0 |
| Example 9 | 98% | 5.0% | 2.6 | 0.007 | No | No | 0/10 | 0 |
| Example 10 | 97% | 4.8% | 2.3% | 0.006 | No | No | 0/10 | 0 |
| Example 11 | 85% | 4.7% | 2.1% | 0.006 | No | No | 0/10 | 0 |
| Example 12 | 40% | 4.0% | 1.9% | 0.005 | No | No | 0/10 | 0 |
| Example 13 | 20% | 3.3% | 1.5% | 0.005 | No | No | 0/10 | 0 |
| Comparative | / | 17.8% | 9.4% | 0.072 | Yes | No | 9/10 | 16 |
| Example 1 | | | | | | | | |
| Comparative | / | 10.2% | 5.7% | 0.035 | Yes | No | 6/10 | 8 |
| Example 2 | | | | | | | | |
| Comparative | / | 15.3% | 10.5% | 0.061 | Yes | No | 7/10 | 12 |
| Example 3 | | | | | | | | |

According to Table 1, comparison between the test results of examples 1 to and comparative examples 1 to 3 shows that through selection of suitable components in appropriate proportions, the binder composite achieves strong adhesion force and electrochemical stability. When applied in electrochemical apparatuses, the binder composite not only reduces the occurrence of internal short circuits resulting from the connection of positive and negative electrode plates in the electrochemical apparatuses, but also reduces side reactions between the binder composite and the electrolyte, thus reducing the formation of purple spots. Therefore, when applied in electrochemical apparatuses, the binder composite in this application can enhance the safety and electrochemical performance of the electrochemical apparatuses.

TABLE 2

| | | | | Adhesion force (N/m) | | Drop test | |
|---|---|---|---|---|---|---|---|
| | | | | Separator | Separator | 24 h | Number |
| | Separator substrate | | | and | and | voltage | of |
| | | First | Second | positive | negative | drop > | separator |
| No. | Material | surface | surface | electrode | electrode | 50 mV | shrinkages |
| Example 14 | PE | Adhesive | / | 14.3 | 14.5 | 0/10 | 0 |
| | | portion | | | | | |
| Example 15 | PE | Ceramic | Adhesive | 13.9 | 14.4 | 0/10 | 0 |
| | | layer + | portion | | | | |
| | | adhesive | | | | | |
| | | portion | | | | | |
| Comparative | PE | Polyacrylic | Polyacrylic | 4.6 | 4.7 | 3/10 | 6 |
| example 4 | | acid | acid | | | | |
| Comparative | PE | Ceramic | Polyacrylic | 4.1 | 4.8 | 4/10 | 9 |
| example 5 | | layer + | acid | | | | |
| | | polyacrylic | | | | | |
| | | acid | | | | | |
| Comparative | PE | PVDF | PVDF | 1.8 | 1.7 | 5/10 | 12 |
| Example 6 | | | | | | | |
| Comparative | PE | Ceramic | PVDF | 1.1 | 1.7 | 5/10 | 17 |
| Example 7 | | layer + | | | | | |
| | | PVDF | | | | | |

According to Table 2, comparison between the test results of Examples 14 and 15 and Comparative Examples 4 to 7 shows that setting the adhesive portion on one side of the separator substrate can enhance the adhesion force between the separator and the positive and negative electrode plates, and reduce the probability of short circuits caused by the connection of the positive and negative electrode plates as well as the number of separator shrinkages in the event of dropping of the electrochemical apparatus, thereby improving the safety and electrochemical performance of the electrochemical apparatus.

In conclusion, it should be noted that the above embodiments are merely intended for describing the technical solutions of this application but not for limiting this application. Although this application is described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of this application. They should all be covered in the scope of the claims and specification of this application. In particular, as long as there is no structural conflict, the various technical features mentioned in the embodiments can be combined in any manner. This application is not limited to the specific embodiments disclosed in this specification but includes all technical solutions falling within the scope of the claims.

1. A binder composite, wherein,
the binder composite comprising the following components based on a mass of the binder composite:
a main resin being 50% to 80% by mass, wherein the main resin comprises isotactic polyolefin resin, syndiotactic polyolefin resin, and atactic polyolefin resin;
a tackifier being 5% to 20% by mass;
a toughener being 5% to 20% by mass; and
a plasticizer being 5% to 10% by mass.

2. The binder composite according to claim 1, wherein based on a mass of the main resin,
a mass percentage of the isotactic polyolefin resin is 40% to 85%;
a mass percentage of the syndiotactic polyolefin resin is 10% to 40%; and
a mass percentage of the atactic polyolefin resin is 5% to 25%.

3. The binder composite according to claim 2, wherein based on the mass of the main resin,
the mass percentage of the isotactic polyolefin resin is 45% to 70%;
the mass percentage of the syndiotactic polyolefin resin is 20% to 35%; and
the mass percentage of the atactic polyolefin resin is 10% to 20%.

4. The binder composite according to claim 3, wherein based on the mass of the main resin,
the mass percentage of the isotactic polyolefin resin is 52% to 65%;
the mass percentage of the syndiotactic polyolefin resin is 25% to 30%; and
the mass percentage of the atactic polyolefin resin is 10% to 18%.

5. The binder composite according to claim 2, wherein the binder composite satisfies at least one of the following conditions (a) to (c):
condition (a): the isotactic polyolefin resin satisfies at least one of the following (I) to (III):
(I) a crystallinity of the isotactic polyolefin resin is 60% to 70%;
(II) an isotacticity of the isotactic polyolefin resin is ≥90%; or
(III) water absorption of the isotactic polyolefin resin is 0.01% to 0.03%.
condition (b): the syndiotactic polyolefin resin satisfies at least one of the following (I) to (V):
(I) a crystallization point of the syndiotactic polyolefin resin is lower than a crystallization point of the isotactic polyolefin resin;
(II) a crystallinity of the syndiotactic polyolefin resin is 20% to 30%;
(III) a melting point of the syndiotactic polyolefin resin is 125° C. to 148° C.;
(IV) a density of the syndiotactic polyolefin resin is 0.7 g/cm³ to 0.8 g/cm³; or
(V) a weight-average molecular weight Mw of the syndiotactic polyolefin resin and a viscosity-average molecular weight Mη of the syndiotactic polyolefin resin satisfy 1.7≤Mw/Mη≤2.6; and
condition (c): a weight-average molecular weight of the atactic polyolefin resin is 3000 to 90000.

6. The binder composite according to claim 1, wherein the tackifier comprises petroleum tackifying resin.

7. The binder composite according to claim 6, wherein the petroleum tackifying resin satisfies at least one of the following (I) and (II):
(I) the petroleum tackifying resin comprises one or more of C5 hydrocarbon tackifying resin and C9 hydrocarbon tackifying resin; and
(II) a weight-average molecular weight of the petroleum tackifying resin is 300 to 3000.

8. The binder composite according to claim 1, wherein the toughener has a functional group that forms hydrogen bonds.

9. The binder composite according to claim 8, wherein the functional group comprises a carboxyl functional group.

10. The binder composite according to claim 9, wherein the toughener comprises one or more of an ethylene-vinyl acetate copolymer or an ethylene-acrylic acid copolymer.

11. The binder composite according to claim 1, wherein,
the plasticizer comprises rubber; wherein,
the rubber comprises one or more selected from the group consisting of butadiene rubber, nitrile rubber, butyl rubber, chlorobutyl rubber, polysulfide rubber, polyurethane rubber, polyacrylate rubber, chlorinated polyethylene rubber, silicone rubber, fluorine rubber, polyisobutylene rubber, isoprene rubber, and ethylene-propylene rubber.

12. The binder composite according to claim 1, wherein based on the mass of the binder composite, the binder composite further comprises
a surfactant, the surfactant being 1% to 5% by mass.

13. The binder composite according to claim 12, wherein the surfactant comprises one or more selected from the group consisting of microcrystalline wax, paraffin wax, montan wax, polyethylene wax, and polypropylene wax.

14. An electrochemical apparatus, comprising:
a negative electrode plate;
a positive electrode plate;
a separator disposed between the positive electrode plate and the negative electrode plate; and
an adhesive portion; wherein,
the adhesive portion is disposed on one side of the separator; wherein,
the adhesive portion is made of a binder composite; wherein,
the binder composite comprises the following components based on a mass of the binder composite:
a main resin being 50% to 80% by mass, wherein the main resin comprises isotactic polyolefin resin, syndiotactic polyolefin resin, and atactic polyolefin resin;
a tackifier being 5% to 20% by mass;
a toughener being 5% to 20% by mass; and
a plasticizer being 5% to 10% by mass.

15. The electrochemical apparatus according to claim 14, wherein based on a mass of the main resin,
a mass percentage of the isotactic polyolefin resin is 40% to 85%;
a mass percentage of the syndiotactic polyolefin resin is 10% to 40%; and
a mass percentage of the atactic polyolefin resin is 5% to 25%.

16. The electrochemical apparatus according to claim 15, wherein the binder composite satisfies at least one of the following conditions (a) to (c):
condition (a): the isotactic polyolefin resin satisfies at least one of the following (I) to (III):
(I) a crystallinity of the isotactic polyolefin resin is 60% to 70%;
(II) an isotacticity of the isotactic polyolefin resin is ≥90%; or
(III) water absorption of the isotactic polyolefin resin is 0.01% to 0.03%.
condition (b): the syndiotactic polyolefin resin satisfies at least one of the following (I) to (V):
(I) a crystallization point of the syndiotactic polyolefin resin is lower than a crystallization point of the isotactic polyolefin resin;
(II) a crystallinity of the syndiotactic polyolefin resin is 20% to 30%;
(III) a melting point of the syndiotactic polyolefin resin is 125° C. to 148° C.;
(IV) a density of the syndiotactic polyolefin resin is 0.7 g/cm³ to 0.8 g/cm³; or
(V) a weight-average molecular weight Mw of the syndiotactic polyolefin resin and a viscosity-average molecular weight Mη of the syndiotactic polyolefin resin satisfy 1.7≤Mw/Mη≤2.6; and
condition (c): a weight-average molecular weight of the atactic polyolefin resin is 3000 to 90000.

17. The electrochemical apparatus according to claim 14, wherein,
the separator comprises a substrate and an extension portion connected to an edge of the substrate;
the extension portion extends beyond the negative electrode plate or the positive electrode plate; and
the adhesive portion is connected between two adjacent extension portions.

18. The electrochemical apparatus according to claim 14, wherein the adhesive portion is provided on a surface of the separator.

19. An electric apparatus, comprising an electrochemical apparatus, wherein,
the electrochemical apparatus comprises:
a negative electrode plate;
a positive electrode plate;
a separator disposed between the positive electrode plate and the negative electrode plate; and
an adhesive portion; wherein,
the adhesive portion is disposed on one side of the separator; wherein,
the adhesive portion is made of a binder composite; wherein,
the binder composite comprises the following components based on a mass of the binder composite:
a main resin being 50% to 80% by mass, wherein the main resin comprises isotactic polyolefin resin, syndiotactic polyolefin resin, and atactic polyolefin resin;
a tackifier being 5% to 20% by mass;
a toughener being 5% to 20% by mass; and
a plasticizer being 5% to 10% by mass.

20. The electric apparatus according to claim 19, wherein based on a mass of the main resin,
a mass percentage of the isotactic polyolefin resin is 40% to 85%;
a mass percentage of the syndictactic polyolefin resin is 10% to 40%; and
a mass percentage of the atactic polyolefin resin is 5% to 25%.
